(19) United States
(12) Patent Application Publication
(10) Pub. No.: US 2016/0371436 A1
(43) Pub. Date: Dec. 22, 2016

(54) SELECTIVE CENSORING OF MEDICAL PROCEDURE VIDEO

(71) Applicant: DRAEGER MEDICAL SYSTEMS, INC, Andover, MA (US)

(72) Inventors: Juan Pablo ESLAVA, Boylston, MA (US); Timothy Joseph COONAHAN, Sterling, MA (US)

(73) Assignee: Draeger Medical Systems, Inc., Andover, MA (US)

(21) Appl. No.: 14/896,657

(22) PCT Filed: Dec. 12, 2014
(86) PCT No.: PCT/US2014/070159

§ 371 Date: Dec. 7, 2015

(51) Int. Cl. G06F 19/00; G06K 9/00; G11B 27/02; G06F 21/62

(52) U.S. Cl. CPC G06F 19/322; G06F 21/6245; G06F 19/324; G06K 9/00362; G11B 27/02

(57) ABSTRACT

Contextual data can be received comprising identification of a medical procedure and a video feed of the medical procedure. Portions of the video feed containing material to-be-censored can be identified. Data for creating a censored video can be generated, the data generated based on the contextual data of the medical procedure and content of the video feed. Related apparatus, systems, techniques, and articles are also described.

### TECHNICAL FIELD

The subject matter described herein relates to censoring of video, for example, in a healthcare setting such as in connection with a medical procedure.

### BACKGROUND

In the course of having or being part of a medical practice, doctors may learn information they wish to share with the medical or research community. If this information is shared or published, the privacy of the patients must be respected. In addition, the advent of electronic medical records has raised new concerns about privacy.

### SUMMARY

In an aspect, contextual data can be received comprising identification of a medical procedure and a video feed of the medical procedure. Portions of the video feed containing material to-be-censored can be identified. Data for creating a censored video can be generated, the data generated based on the contextual data of the medical procedure and content of the video feed.

One or more of the following features can be included in any feasible combination. For example, the video feed can be analyzed to acquire a unique identifier from a data marker associated with a medical device. The medical procedure being performed in the video feed can be determined using the unique identifier. Generating data for creating the censored video can include generating a video overlay for combining with the video feed. Generating data for creating the censored video can include directly modifying the video feed. Generating data for creating the censored video can include generating metadata specifying to-be-censored areas for further processing of the video feed.

Contextual data can further include data characterizing body part identification. Contextual data can further include data characterizing persons automatically identified in an optical sensor field of view. Contextual data can include video and audio record objects. Contextual data can include wireless detection of objects. Contextual data can include timestamps. Contextual data can include geo-location information for objects in an optical sensor field of view. The contextual data can be received wirelessly.

The data for creating the censored video can be transmitted to a remote database for archiving. Censoring the video feed can obscure one or more of a patient's face, a patient's identity, and a patient's genitals.

One or more privacy levels can be determined according to the medical procedure. Different portions of the video feed can be associated with different levels of privacy. The censored video overly can be combined with the video feed to produce the censored video according to at least one of the one or more privacy levels. The censored video can be provided to a user. The video feed of the medical procedure can be captured by an optical sensor in operation with the at least one data processor. The at least one data processor can be in operation with the optical sensor to form a wearable computing device. The censored video can be for protecting a patient's privacy.

Computer program products are also described that comprise non-transitory computer readable media storing instructions, which when executed by at least one data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many technical advantages. For example, in an implementation, censorship for hospital acquired video can be automated and a process for censoring the video can be streamlined according to needs of a few without costly post processing steps. Additionally, videos can be censored based on the medical procedure that is performed, which can improve processing efficiency and accuracy.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram of an example process for censoring a video of a medical procedure based on the medical procedure and performed to protect a patient's privacy;

FIG. 2 is a system block diagram illustrating an example medical procedure video censoring system;

FIG. 3 is a series of drawings illustrating algorithms for identification of portions of a video feed to-be-censored; and

FIG. 4 is an illustration of an example video feed frame that has been censored.

### DETAILED DESCRIPTION

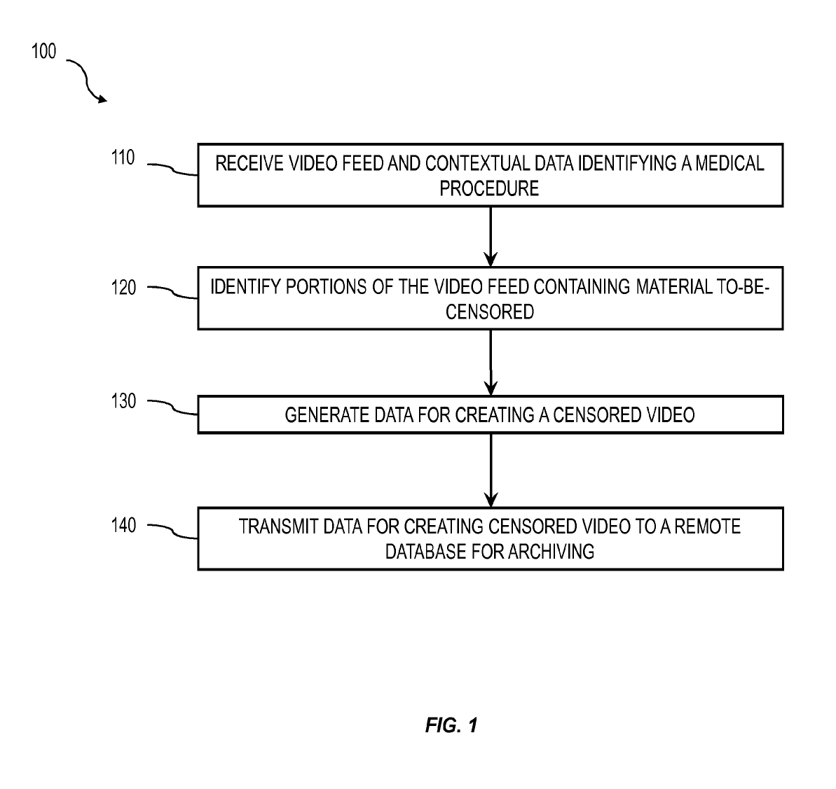

FIG. 1 is a process flow diagram of an example process 100 for selectively censoring a video of a medical procedure based on the medical procedure and, in some implementations, can be performed to protect a patient's privacy. Many hospitals or health care facilities require video recording of medical procedures for quality control, teaching, to generate medical records, and/or for insurance purposes. However, generation of medical procedure videos risks the patient's privacy. In some implementations, the medical procedure can be automatically determined from contextual knowledge of the medical devices and/or instruments being used. Knowledge of the medical procedure can be used to selectively and automatically censor the video. In some implementations, the processing is performed before the video is stored in a database to reduce the risk to the patient's privacy.

A video feed and contextual data can be received at 110. The video feed can be from a camera and can be of a medical procedure. The contextual data can identify the medical procedure. For example, the medical procedure can include a tracheal intubation, which may be commonly video recorded in some hospitals.

In some implementations, the video feed can be analyzed to identify the medical procedure. This can include deriving contextual information from the video feed. For example, this can include processing the video feed using image processing techniques to identify one or more data markers on medical devices and/or instruments being used in the medical procedure (which may appear in the video feed) as well as applying a rule set or another algorithm to determine the medical procedure. A data marker can include a unique identifier that identifies the medical device. The identifier can include an alpha numeric or binary number, which can be encoded within a data marker. The identifier for a given medical device/instrument or data marker can be unique in that it uniquely identifies the associated medical device/instrument or data marker. For example, the identifier can be the uniform resource locator (URL) of the associated medical device on a network. The identifier can be a unique device identifier (UDI) issued by a United States Food and Drug Administration accredited agency. The identifier may be unique worldwide, within a hospital system, and/or within a clinical care unit. The data marker can include a sticker with a barcode, such as a matrix barcode or two-dimensional barcode, although other indicia such as plaintext are possible. In some implementations, the medical device can display the data marker. The medical procedure can be determined from the unique identifier(s).

Another example of deriving contextual data from the video feed can include identifying body parts. Body part identification can be performed using image processing techniques. Once a body part is identified, it can be used as a basis for censoring the video feed.

Another example of deriving contextual data from the video feed can include identifying objects or markings that are not visible to the naked eye but can be discerned using a camera or a camera and filter. For example, a polarizing filter can be used to identify markings, patterns, and the like, that are printed in “invisible” ink (e.g., infrared ink).

In some implementations, the contextual data can be received wirelessly. For example, medical devices and instruments can include a wireless module, such as a module based on BLUETOOTH® or ZIGBEE® protocol and the medical device and instrument can be queried for their identification information, which can be transmitted by the wireless module. In some additional implementations, a user can manually enter the contextual data by identifying the medical procedure being recorded.

In some implementations, the contextual data can be derived from the camera and additional sensors. In an implementation, the camera is part of a wearable computing device that is worn in a hospital and can include a multitude of subsystems that are not limited to a central processing unit (CPU), camera, microphone, user touch interface, high resolution display, radio and receiver. The wearable device has mobile context awareness and can automatically identify persons in its field of view, video and audio record objects and/or events that are coming to and leaving its field of view, detect objects that send short or long range radio and/or optical signals, place timestamps and geo-location information for objects in its field of view during archiving of recording. The wearable device can store digital information using metatags or metadata in its onboard memory or on a remote storage device via a wireless communication link. The wearable device can execute tasks or commands using software that is pre-programmed and stored on board or called up on demand from a remote computer such as a server and can be triggered to perform tasks automatically using its contextual awareness.

Portions of the video feed containing material to-be-censored can be identified at 120. This can include, for example, identifying a patient's face, identity revealing information (e.g., printed indicia indicating patient's name, body tattoos, birthmarks, religious or tribal markings, scars from injury, scars from prior surgeries, scars from immunization, other body modifications, and the like), and the patient's genitals. The patient's face can be identified using facial recognition software. In some implementations, different portions of the video feed are associated with different levels of privacy. For example, a patient's face (and/or portions thereof), identity revealing information, and genitals can each be associated with different levels of privacy. In addition, a level of privacy may be determined according to the medical procedure. For example, if the medical procedure is performed on a portion of the body that is near the face, the privacy level may relate only to censoring the patient's face. Identified body parts can be used as a basis for censoring the video feed.

Data for creating a censored video can be generated at 130. The data for creating a censored video can include, for example, a directly modified video feed, metadata specifying to-be-censored areas for further processing of the video feed, and a video overlay for combining with the video feed to create the censored video. The generating of the data can be based on previously received and/or determined contextual data of the medical procedure as well as the content of the video feed. In some implementations, the censored video is for protecting the patient's privacy.

Data for creating the censored video can be transmitted at 140 to a remote database for archiving. The raw video feed can also be transmitted to the remote database. In some implementations, the raw video feed can be further processed to create one or more censored videos according to one or more privacy levels, which can be stored for later retrieval. In some implementations, the data for creating the censored video and the raw video feed can be stored in the database and, when a user requests access to the video, can be further processed to create a censored video according to the privacy level that is appropriate for the requesting user. For example, a previously generated censored video overly can be combined with the raw video feed to produce a censored video according to the one or more privacy levels. The censored video can also be provided to a user.

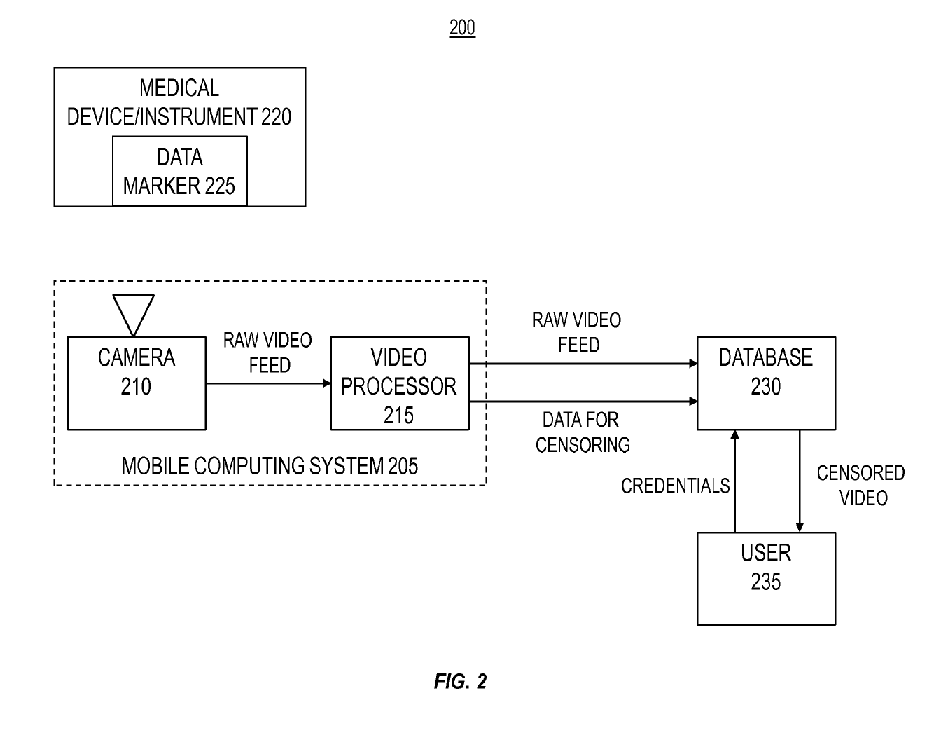

FIG. 2 is a system block diagram illustrating an example medical procedure video censoring system 200. A mobile computing system 205 includes a camera 210 or optical sensor in operation with at least one data processor forming a video processor 215. The camera 210 can include audio recording capabilities in addition to visual recording or capture capabilities. Mobile computing system 205 can include a wearable computing device, such as a GOGGLE GLASS® or EPSON MOVERIO® in which the field of view of the optical sensor overlaps with the field of view of the wearer when the wearable device is worn so that the optical sensor “sees” what the wearer sees. In this example implementation, a video feed produced by camera 210 is from the point-of-view of the wearer. Thus whatever the wearer “looks” at, is included in the video feed. In some implementations, the wearer can be a physician or other health care provider who is involved in performing the medical procedure. Although FIG. 2 illustrates a mobile computing system 205, in some implementations the camera 210 and video processor 215 may be separate, remote, and may not be mobile.

The camera 210 records a medical procedure in which one or more medical devices or instruments 220 may be used. The medical device or instrument 220 can include data marker 225, such as a two-dimensional barcode, that has an encoded identifier. The medical device or instrument 220 may also transmit an identifier to the mobile computing system 205 wirelessly. The camera 210 provides the raw video feed of the medical procedure to the video processor 215, which can receive the raw video feed. The video processor 215 can determine the medical procedure by identifying medical devices and instruments used in the procedure (or being provided the medical device/instrument identities), and process the raw video feed to generate data for creating a censored video (for example, as described more fully with respect to FIG. 1).

The raw video feed can be transmitted over a network to a database 230 for archiving. In some implementations, the raw video feed can be further processed to create one or more censored videos according to one or more privacy levels, which can be stored for later retrieval. A user 235 can request access to the censored video by providing credentials to the database 230. Depending on the access rights of the user, the database 230 can provide a video censored at the corresponding privacy level. For example, if the user is the patient, the user may receive the raw video feed without any censoring. If the user is a student accessing the video for educational purposes, the user may receive a heavily censored video, in which the entire face, genitals, and other identifying information is censored.

In some implementations, the data for creating the censored video and the raw video feed can be stored in the database and, when a user requests access to the video, can be further processed to create a censored video according to the privacy level that is appropriate for the requesting user. Such an implementation saves database storage space at the cost of processing requirements when the user requests a video.

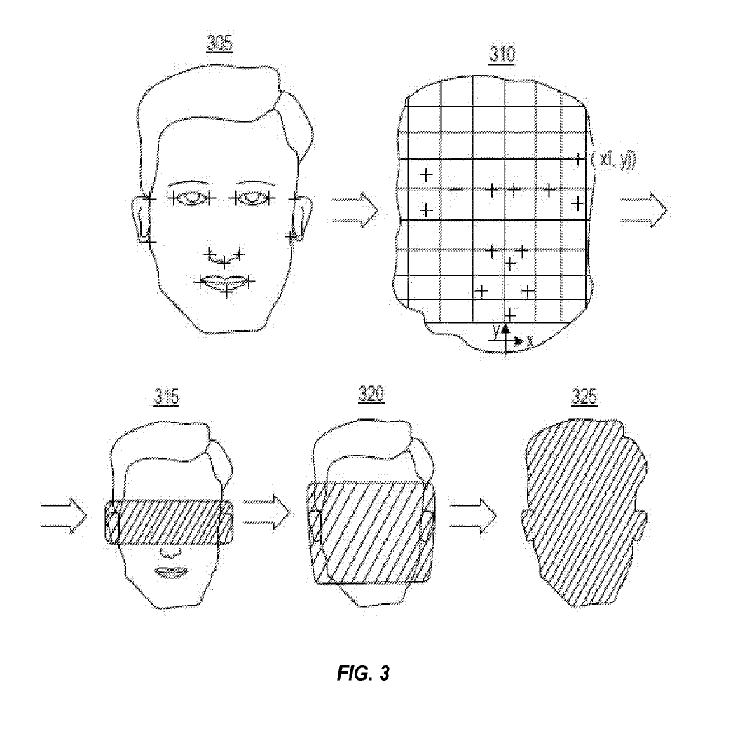

FIG. 3 is a series of drawings 300 illustrating algorithms for identification of portions of a video feed to-be-censored. For each frame in the video feed, a facial recognition algorithm can identify nodes on a person's face. Typical faces can contain an average of 80 nodes. Each node can be identified at 305 and the distance between nodes can be used to perform facial landmark recognition and identification at 310. Regions of the face can then be defined that relate to different levels of privacy. For example, at 315, a narrow region over a patient's eyes is identified for censoring for a lower level of privacy. At 320, a larger region of the patient's face is identified, including the patient's eyes, ears, nose, and mouth, which can correspond to a medium level of privacy. At 325, a region covering the patient's entire head is identified for a high level of privacy. In some implementations, a video overlay or meta-data can be generated that describes each identified region and can be used to censor the video.

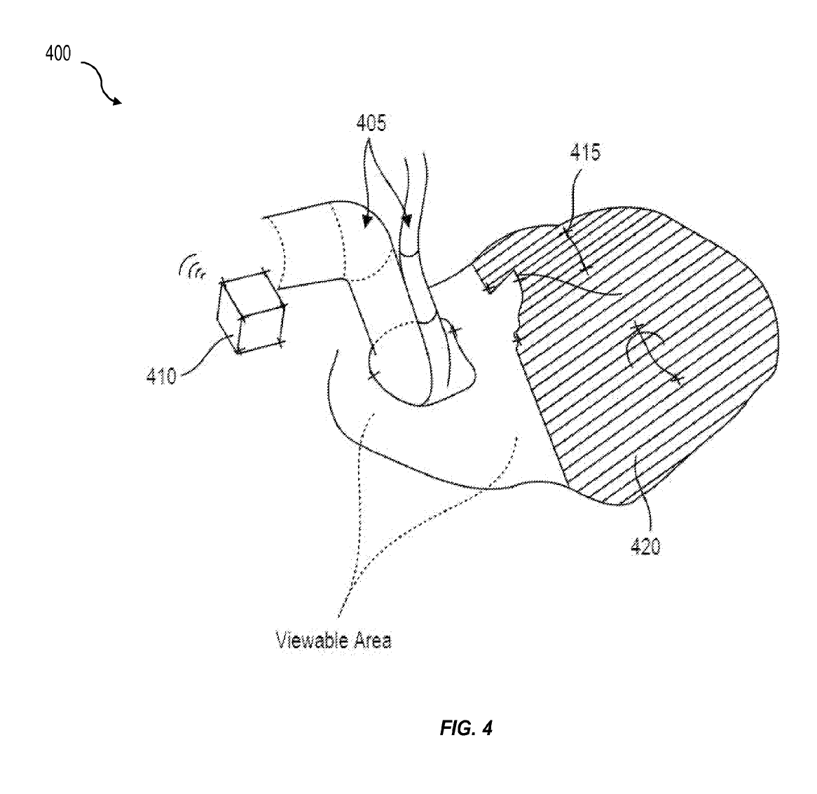

FIG. 4 is an illustration of an example video feed frame that has been censored. Medical devices and/or instruments 405 are visible in the frame. At least one of the medical devices 405 includes a beacon 410 that transmits a device identifier wirelessly. The device identify can be used to determine the type of procedure being recorded in the video feed (in the example of FIG. 4, a respiratory related procedure), which can indicate that the patient's face should be censored, but also that the mouth region should not be censored because it is a region in which the medical procedure is being performed. Nodes 415 are determined (e.g., as described more fully with respect to FIG. 3) and a region 420 or zone is censored. Thus, knowledge of the medical procedure can be used to appropriately and automatically censor the video and enable protection of the patient's privacy.

Although a few variations have been described in detail above, other modifications are possible. For example, the current subject matter is not limited to a wearable device with a camera, but can include any optical sensor and the data processing may occur in operation with the optical sensor and/or remote from the optical sensor. The video feed is not limited to visual images but can include audio recording as well, and censoring may also be of the audio recording. The video feed and associated data can be encrypted at any stage for security. Censoring can include blocking, removing, covering, or otherwise obscuring. Contextual data is not limited to the medical devices or instruments used in the procedure but can also include the location within the healthcare facility (e.g., operating room, emergency room, prep room, and the like) and the individuals involved in the operation (e.g., the identities of the physicians). The processing may be performed in real time or in near real time.

Various implementations of the subject matter described herein may be realized in digital electronic circuitry, integrated circuitry, specially designed ASICs (application specific integrated circuits), computer hardware, firmware, software, and/or combinations thereof These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the implementations described above can be directed to various combinations and subcombinations of the disclosed features and/or combinations and subcombinations of several further features disclosed above. In addition, the logic flows depicted in the accompanying figures and described herein do not require the particular order shown, or sequential order, to achieve desirable results. Other embodiments may be within the scope of the following claims.

1. A method for implementation by at least one hardware data processor forming part of at least one computing device, the method comprising:
receiving, by at least one data processor, contextual data comprising identification of a medical procedure and a video feed of the medical procedure;
identifying, by at least one data processor, portions of the video feed containing material to-be-censored; and
generating, by at least one data processor, data for creating a censored video in which at least one area within frames of the video is censored while other sections within such areas within the frames of the video are not censored, the data generated based on the contextual data of the medical procedure and content of the video feed.

2. The method of claim 1, further comprising:
analyzing the video feed to acquire a unique identifier from a data marker associated with a medical device; and
determining, using the unique identifier, the medical procedure being performed in the video feed.

3. The method of claim 1, wherein generating data for creating the censored video includes generating a video overlay for combining with the video feed.

4. The method of claim 1, wherein generating data for creating the censored video includes directly modifying the video feed.

5. The method of claim 1, wherein generating data for creating the censored video includes generating metadata specifying to-be-censored areas for further processing of the video feed.

6. The method of claim 1, wherein contextual data further includes data characterizing body part identification.

7. The method of claim 1, wherein contextual data further includes data characterizing persons automatically identified in an optical sensor field of view.

8. The method of claim 1, wherein contextual data further includes video and audio record objects.

9. The method of claim 1, wherein contextual data further includes wireless detection of objects.

10. The method of claim 1, wherein contextual data further includes timestamps.

11. The method of claim 1, wherein contextual data further includes geo-location information for objects in an optical sensor field of view.

12. The method of claim 1, wherein different portions of the video feed are associated with different levels of privacy.

13. The method of claim 1, wherein the contextual data is received wirelessly.

14. The method of claim 1, further comprising:
transmitting, by at least one data processor, the data for creating the censored video to a remote database for archiving.

15. The method of claim 1, wherein censoring the video feed obscures sections corresponding to one or more of a patient's face, a patient's identity, and a patient's genitals.

16. The method of claim 3 further comprising:
determining, by at least one data processor, one or more privacy levels according to the medical procedure;
combining the censored video overlay with the video feed to produce the censored video according to at least one of the one or more privacy levels; and
providing the censored video to a user.

17. The method of claim 1, wherein the video feed of the medical procedure is captured by an optical sensor in operation with the at least one data processor.

18. The method of claim 1, wherein the at least one data processor in operation with the optical sensor form a wearable computing device.

19. The method of claim 1, wherein the censored video is for protecting a patient's privacy.

20. A system comprising:
at least one hardware data processor; and
memory storing instructions which, when executed by the at least one data processor, implement operations comprising:
receiving contextual data comprising identification of a medical procedure and a video feed of the medical procedure;
identifying portions of the video feed containing material to-be-censored; and
generating data for creating a censored video in which at least one area within frames of the video is censored while other sections within such areas within the frames of the video are not censored, the data generated based on the contextual data of the medical procedure and content of the video feed.

21. (canceled)
